(19) United States
(12) Patent Application Publication
(10) Pub. No.: US 2009/0078166 A1
(43) Pub. Date: Mar. 26, 2009

(54) Hinged Track Plate Apparatus for Removing Debris From Tires

(76) Inventors: Dana Prest, Rancho Cucamonga, CA (US); Jeffery S. Mitchell, Lake Elsinore, CA (US); Bruce R. Degler, Fontana, CA (US)

Correspondence Address: PATENT VENTURE GROUP, 10788 CIVIC CENTER DRIVE, SUITE 215, RANCHO CUCAMONGA, CA, 91730, US

(21) Appl. No.: 11/861,159

(22) Filed: Sep. 25, 2007

(51) Int. Cl. F16S 3/08

(52) U.S. Cl. 108/7

(57) ABSTRACT

An invention is provided for a hinged track plate apparatus for removing debris from tires. The apparatus includes a base plate a width and length substantially greater than a thickness of the base plate. In addition, a track plate assembly is hingably attached to the base plate at an edge and disposed above the base plate. The track plate assembly includes a plurality of track plates connected to a plurality of track supports, with each track plate having a length substantially greater than a height and thickness of the track plate. The track plate assembly can be moved away from the base plate about the hingably attached edge. Further, a lifting ram is hingably connected to the base plate and the track plate assembly. The lifting ram is capable of moving the track plate assembly away from the base plate when the lifting ram is extended.

### BACKGROUND OF THE INVENTION

1. Field of the Invention

This invention relates generally to track plates, and more particularly to a hinged track plate for removing debris from tires.

2. Description of the Related Art

In today's construction projects, vehicles often are required to travel in an unpaved environment. As such, these vehicles generally accumulate mud, dirt, and other debris on their tires. That is, the mud and other debris tend to collect in the tire treads, reducing the effective depth of the treads creating hazardous driving conditions. In addition, when these vehicles leave the unpaved environment, the mud and other debris accumulated on the tires is transferred to the surrounding roads. Since city regulations generally require contractors to ensure these vehicles do not spread excessive amounts of dirt, mud, and other debris onto adjoining roads, the tires of these vehicles typically must be cleaned in some manner prior to the vehicles leaving the construction site.

Various tire cleaning methods have been utilized to remove debris from vehicle tires, including pressurized washing and vibration-inducing surfaces for removing debris from tires as the vehicle is driven over the surface. Such vibration-inducing surfaces generally are created from a series of beams over which the vehicle drives, such as the shaker plates illustrated in FIG. 1A.

FIG. 1A is a prior art shaker plate apparatus 100 providing a vibration-inducing surface for removing dirt and other debris from tires. The shaker plate apparatus 100 includes a plurality of beams 102 or tracks connected to a base 104. Typically, the beams 104 are about four inches in height and spaced six to twelve inches apart. In operation, a vehicle is driven across the top surface of the shaker plate apparatus 100 in the direction of the arrow 108 to clean the vehicles tires. The vibration inducted by the surface cleans dirt, mud, and other debris from the tires. However, as dirt and other debris is removed from the tires of successive vehicles, the dirt and other debris from the tires accumulates between the beams 102, as illustrated in FIG. 1B.

FIG. 1B is a detailed view of a section of the prior art shaker plate apparatus 100 showing debris buildup between beams 102. As illustrated in FIG. 1B, debris 106 from vehicle tires builds up between the beams 102 and the base 104 as vehicles are driven across the surface of the shaker plate apparatus 100. This debris 106 severely reduces the effectiveness of the of the shaker plate apparatus 100, and as a result, must be cleaned periodically.

Unfortunately, because the beams 102 are rigidly affixed to the base 104, the task of cleaning of the debris 106 from the base 104 the beams 102 is a very time consuming. A typical shaker plate apparatus 100 weighs approximately three thousand pounds per panel and thus cannot easily be moved. As a result, a worker generally must use a small shovel or other dirt removal device to dig out the debris 106 from between the beams 102. Large cleaning devices generally cannot fit in between the beams 102 because the beams 102 are rigidly fixed relatively close together on the base 104, and thus generally cannot be used to clean the shaker plate apparatus 100.

In view of the foregoing, there is a need for a tire cleaning apparatus that allows for easy maintenance. The apparatus should provide effective tire cleaning to remove dirt, mud, and other debris from vehicle tires and treads. In addition, the apparatus should allow for easy maintenance that can be performed in a relatively short time.

### SUMMARY OF THE INVENTION

Broadly speaking, the present invention addresses these needs by providing an hinged track plate apparatus for removing debris from tires that allows the track plates to be lifted away from the base plate for easy maintenance. For example, in one embodiment an apparatus for removing debris from tires is disclosed. The apparatus includes a base plate having a width and length substantially greater than a thickness of the base plate. Disposed above the base plate is a track plate assembly that includes a plurality of track plates connected to a plurality of track supports. Each track plate can be a beam-like strip, having a length substantially greater than a height and thickness of the track plate. In addition, one or more hinges are connected to the track plate assembly and the base plate, allowing the track plate assembly to be moved away from the base plate about the hinge. In one embodiment, a predefined plurality of track plates near an edge of the track plate assembly has a height lower than track plates located centrally in the track plate assembly. For example, each track plate of the predefined plurality of track plates near the edge of the track plate assembly can have a greater height than the track plate closer to the edge of the track plate assembly, thus creating a ramping effect that facilitates entry onto the hinged track plate apparatus.

A further apparatus for removing debris from tires is disclosed in an additional embodiment of the present invention that includes a lifting ram. In this embodiment, the apparatus includes a base plate a width and length substantially greater than a thickness of the base plate. In addition, a track plate assembly is hingably attached to the base plate at an edge and disposed above the base plate. As above, the track plate assembly includes a plurality of track plates connected to a plurality of track supports, with each track plate having a length substantially greater than a height and thickness of the track plate. Also as above, the track plate assembly can be moved away from the base plate about the hingably attached edge. Further, a lifting ram is hingably connected to the base plate and the track plate assembly. The lifting ram is capable of moving the track plate assembly away from the base plate when the lifting ram is extended. In one embodiment, the lifting ram can be a hydraulic ram. In this case, the hydraulic ram may be connected to a hydraulic pump can. The hydraulic pump can supplies hydraulic fluid, which can be a water mixture, to the hydraulic ram to facilitate use the hydraulic ram.

To assist in lifting the track plate assembly, a cam lift assembly may be included that is hingably connected to the track plate assembly and the lifting ram. The cam lift assembly is capable of allowing an end of the lifting ram to rise above the track plate assembly to assist in lifting the track plate assembly from the base plate. The cam lift assembly may include a cam connected to a cam housing via a cam pin. The cam housing is further coupled to a cam stop that prevents the cam from rotating beyond a predetermined position. Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1A is a prior art shaker plate apparatus that provides a vibration-inducing surface for removing dirt and other debris from tires;

FIG. 1B is a detailed view of a section of the prior art shaker plate apparatus showing debris buildup between beams;

FIG. 2A is an illustration showing an exemplary hinged track plate apparatus, in accordance with an embodiment of the present invention;

FIG. 2B is an illustration showing an exemplary hinged track plate apparatus having a lifting ram, in accordance with an embodiment of the present invention;

FIG. 3 is an illustration showing an exemplary hinged track plate apparatus having the track plate assembly raised for maintenance, in accordance with an embodiment of the present invention;

FIG. 4A is a diagram showing an exemplary hinge in a closed position for normal operation, in accordance with an embodiment of the present invention;

FIG. 4B is a diagram showing an exemplary hinge in an open position for maintenance operations, in accordance with an embodiment of the present invention;

FIG. 5A is a cross sectional view of a hinged track plate apparatus, in accordance with an embodiment of the present invention;

FIG. 5B is a cross sectional view of two hinged track plate apparatuses attached together via attachment means, in accordance with an embodiment of the present invention;

FIG. 6A is a diagram showing a cam lift assembly in a closed position when the track plate assembly is resting on the base plate, in accordance with an embodiment of the present invention;

FIG. 6B is a diagram showing a cam lift assembly in an opened position when the track plate assembly is in a maintenance position above the base plate, in accordance with an embodiment of the present invention.

### DETAILED DESCRIPTION OF THE PREFERRED EMBODIMENTS

An invention is disclosed for a hinged track plate that removes dirt, mud, and other debris from vehicle tires and allows for easy maintenance. Broadly speaking, embodiments of the present invention provide a track plate assembly hingably attached to a base plate. The track plate assembly provides a vibration-inducing surface to clean vehicle tires and treads, while dirt, mud, and other debris are collected on the base plate. The track plate assembly can thereafter be lifted away from the base plate about the hinges to allow for easy removal of dirt, mud, and other debris from the base plate. In addition, a lifting ram can also be included to provide lifting force to assist in raising the track plate assembly from the base plate.

In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

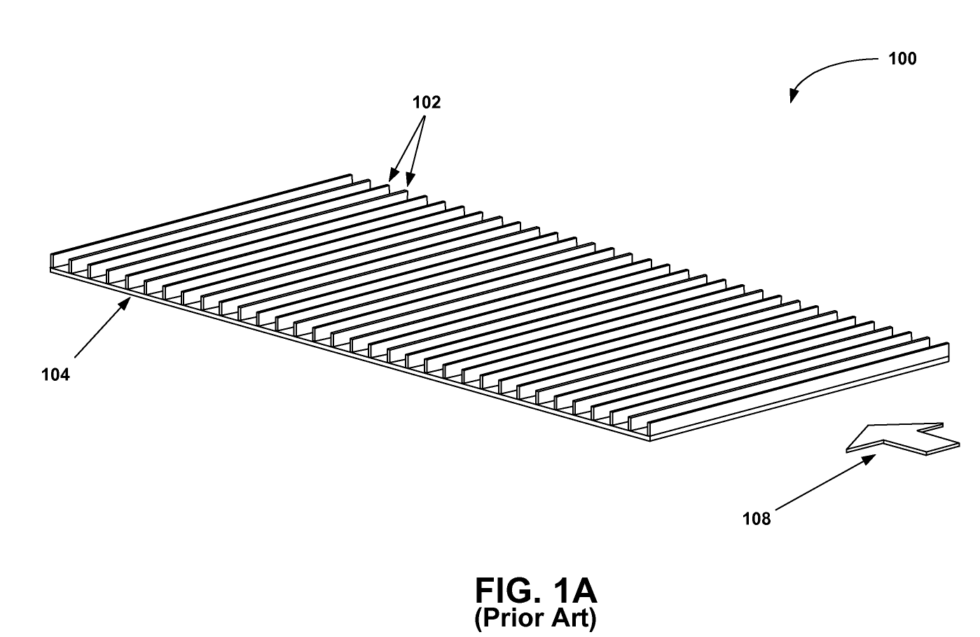

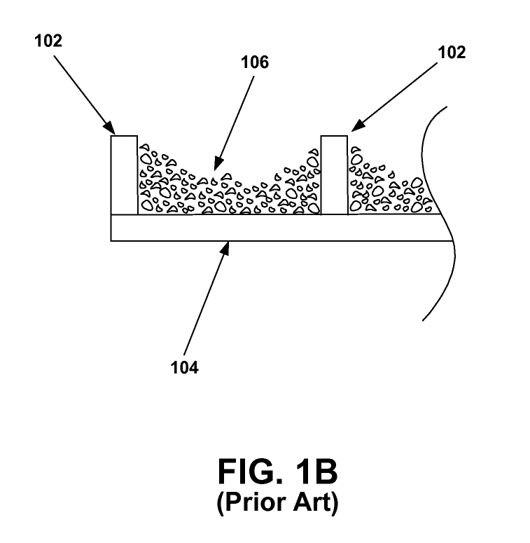

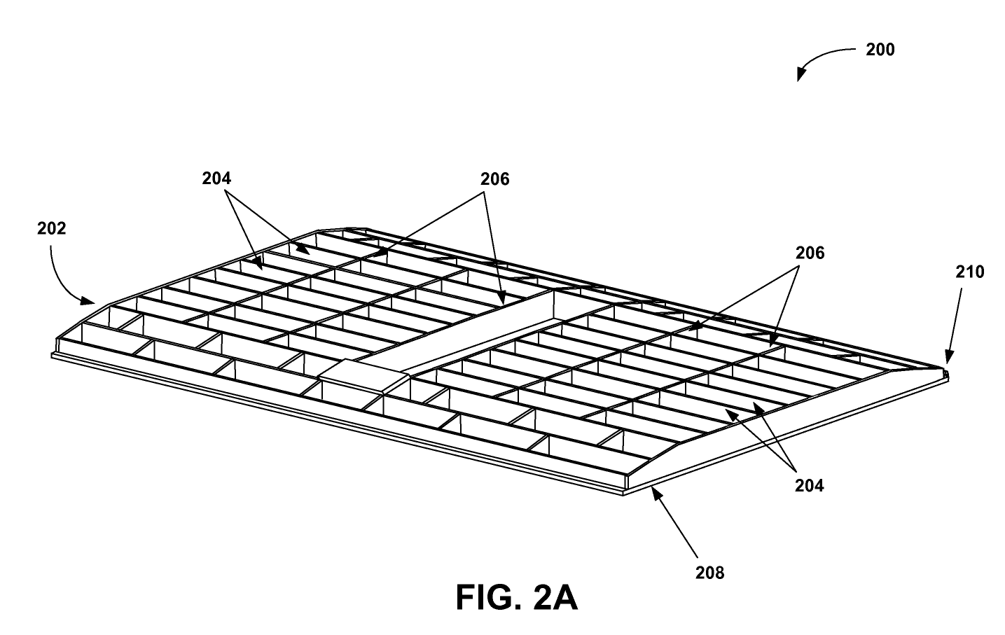

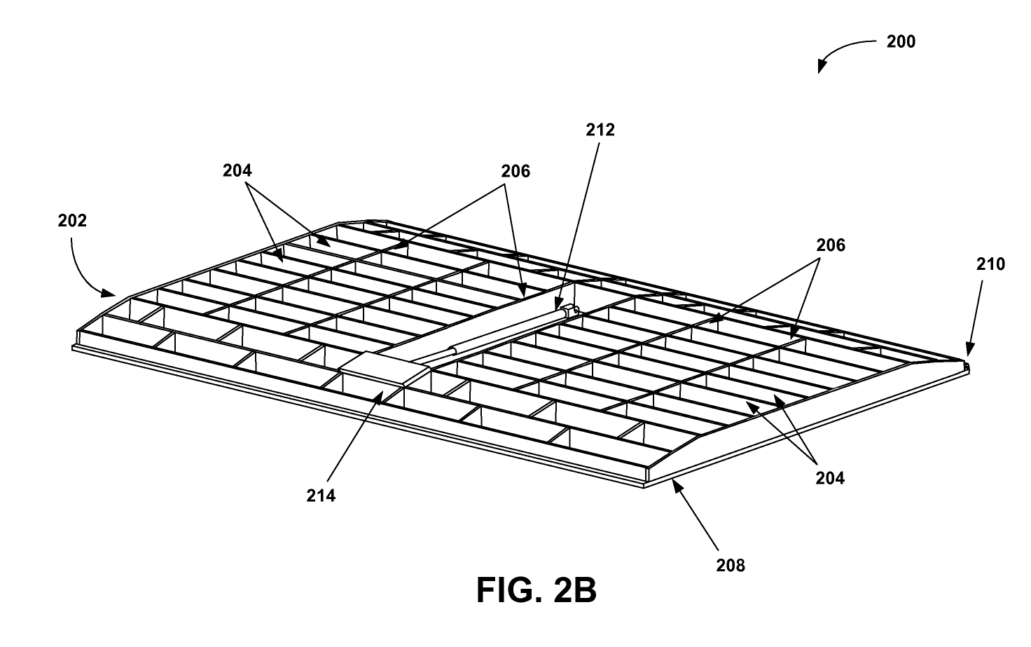

FIG. 1 was described in terms of the prior art. FIG. 2A is an illustration showing an exemplary hinged track plate apparatus 200, in accordance with an embodiment of the present invention. The exemplary hinged track plate apparatus 200 includes a track plate assembly 202 hingably attached to a base plate 208. In one embodiment, the base plate 208 and track plate assembly 202 have a width in the range of about eight to twelve feet and a length in the range of about four to six feet. For example, one embodiment of the present invention includes a base plate 208 and track plate assembly 202 having a width of about ten feet and a length of about five feet. However, it should be noted that embodiments of the present invention can be manufactured in any size suitable for use with vehicles. In addition, the base plate 208 has a width and length substantially greater than the thickness of the base plate. For example, in FIG. 2A, the base plate 208 has a thickness of approximately one inch, however, it should be noted that the base plate 208 of the embodiments of the present invention can have any thickness that provides a suitable base for the track plate assembly 202.

The track plate assembly 202 comprises a plurality of track plates 204 arranged in parallel. Each track plate has a length substantially greater than the height and thickness of the track plate. For example, in one embodiment, the track plates 204 have a height in the range of about three to five inches. For example, in the embodiment of FIG. 2A the track plates 204 have a height of about four inches. However, it should be noted that the track plates 204 of the embodiments of the present invention can be manufactured to have any height that is suitable for removing dirt, mud, and other debris from vehicle tires. Moreover, as will be described in greater detail subsequently, in one embodiment of the present invention the track plate 204 height varies near the edges of the track plate assembly 202 so as to provide easy access to the track plate 204 and/or to induce additional vibration when multiple hinged track plates 200 are assembled together.

Affixed to the plurality of track plates 204 is a plurality of track supports 206. In one embodiment, as illustrated in FIG. 2A, the track supports 206 are arranged substantially parallel to one another and substantially perpendicular to the plurality of track plates 206. However, it should be noted that the plurality of track supports 206 can be arranged in any manner so as the track supports 206 provide support for the track plates 204 and connect the track plates 204 so as to form a track plate assembly 202 that can be moved as one unit.

The exemplary hinged track plate apparatus 200 further includes one or more hinges 210 attached to both the track plate assembly 202 and the base plate 208. The hinges 210 allow the track plate assembly 202 to be lifted away from the base plate 208 about the hinges 210. It should be noted that any means can be utilized to lift the track plate assembly 202 from the base plate 208, such as manual lifting, chains, spring loaded mechanisms, an air powered mechanisms, an electric powered mechanisms, a hydraulic powered mechanisms, or any other method of lifting as will be apparent to those skilled in the art after a careful reading of the present disclosure.

For example, FIG. 2B is an illustration showing an exemplary hinged track plate apparatus 200 having a lifting ram 212 to assist in lifting the track plate assembly 202 above the base plate 208, in accordance with an embodiment of the present invention. As illustrated in FIG. 2B, one end of the lifting ram 212 is hingably attached to the base plate 208 and the other end of the lifting ram 212 is coupled attached to the track plate assembly 202. In one embodiment, the lifting ram 212 is coupled to the track plate assembly 202 via a cam lift assembly 214.

As will be discussed in greater detail subsequently, the cam lift assembly 214 of the embodiments of the present invention allows the end of the lifting ram 212 coupled to the cam lift assembly 214 to rise above the track plate assembly 202 prior to raising the track plate assembly 202 from the base plate 208. In this manner, the lifting ram 212 can more easily focus upward force to provide the lifting force needed to raise the track plate assembly 202. Optionally, a lifting ram cover (not shown) can be disposed above the lifting ram 212 to add further protection for the lifting ram 212. In this embodiment, the lifting ram cover comprises a relatively thin section of material hingably attached to the track plate assembly 202 at a point opposite the cam lift assembly 214. In this manner, the lifting ram cover can raise slightly when the cam lift assembly 214 raises the lifting ram 212 above the track plate assembly 202. Then, when the track plate assembly 202 is in the closed position, illustrated in FIG. 2B, the lifting ram cover falls back against the track plate assembly 202.

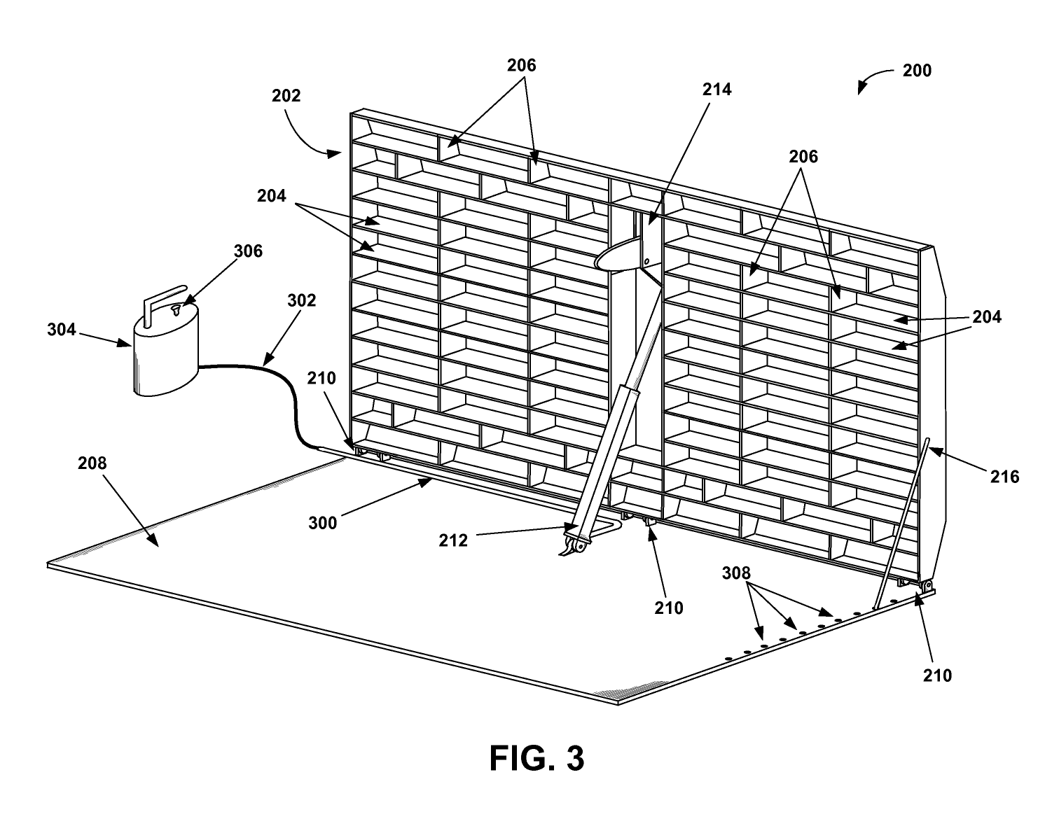

In one embodiment, the hinged track plate apparatus 200 further includes a track plate stand 216 attached to the track plate assembly 202. In operation, the track plate stand 216 can be extended to provide extra support for the track plate assembly 202 when the track plate assembly 202 is raised. Thus, the track plate stand 216 provides additional safety during maintenance, as illustrated next with reference to FIG. 3.

FIG. 3 is an illustration showing an exemplary hinged track plate apparatus 200 having the track plate assembly 202 raised for maintenance, in accordance with an embodiment of the present invention. As with FIG. 2B, the hinged track plate apparatus 200 of FIG. 3 includes a base plate 208 hingably attached to a track plate assembly 202, which includes a plurality of track plates 204 arranged in parallel. Affixed to the plurality of track plates 204 is a plurality of track supports 206. In addition, one or more hinges 210 are attached to both the track plate assembly 202 and the base plate 208, which allow the track plate assembly 202 to be lifted away from the base plate 208 about the hinges 210. To assist in lifting the track plate assembly 202, a lifting ram 212 is included having one end hingably attached to the base plate 208 and the other end coupled to the track plate assembly 202 via a cam lift assembly 214.

To avoid the risk of hazardous materials, one embodiment of the present invention utilizes a hydraulic ram as a lifting ram 212. In this embodiment, the hydraulic ram 212 is attached to a hydraulic metal tube 300, which is connected to the track plate assembly 202. In addition, a flexible hydraulic hose 302 is coupled to both the hydraulic metal tube 300 and a hydraulic pump can 304, which includes a release valve 306. In operation, the hydraulic pump can 304 is utilized to pump hydraulic fluid through the hydraulic hose 302, the hydraulic metal tube 300, and into the hydraulic ram 212. The hydraulic fluid provides the pressure necessary to expand the hydraulic ram 212, lifting the track plate assembly 202.

The release valve 306 is then utilized to lower the track plate assembly 202 by allowing the hydraulic fluid to flow out of the hydraulic ram 212, through the hydraulic hose 302, the hydraulic metal tube 300, and back into the hydraulic pump can 304. Generally, the hydraulic fluid is water or a water mixture, such as soap and water. Since water or water mixture is utilized with the hydraulic ram 212, generally there is no risk of hazardous materials being present should the hydraulic ram 212 break or the hydraulic metal tube 300, hydraulic hose 302, or hydraulic pump can 304 rupture.

As illustrated in FIG. 3, when the track plate assembly 202 is lifted away from the base plate 208 about the hinges 206, the surface of the base plate 208 can be easily cleaned to remove dirt, mud, and other debris that can be present after repeated use of the hinged track plate apparatus 200. In general, dirt, mud, and other debris falls from the track plate assembly 202 onto the base plate 208 when the track plate assembly 202 is lifted away from the base plate 208. Since the track plates 204 no longer obstruct the surface of the base plate 208, the dirt, mud, and other debris can then be easily removed from the base plate 208 in a relatively short amount of time.

For additional safety, the track plate stand 216 can be extended. In one embodiment, track plate stand stops 308 are included in the base plate 208. The track plate stand 216 falls into the track plate stand stops 308 as the track plate assembly 202 is raised. Using the track plate stand stops 308, the track plate stand 216 prevents the track plate assembly 202 from falling back onto the base plate 208 should the lifting ram 212 fail or be inadvertently lowered. After maintenance, the track plate stand 216 can be removed from the track plate stand stops 308 to allow the track plate assembly 202 to be lowered back onto the base plate 208.

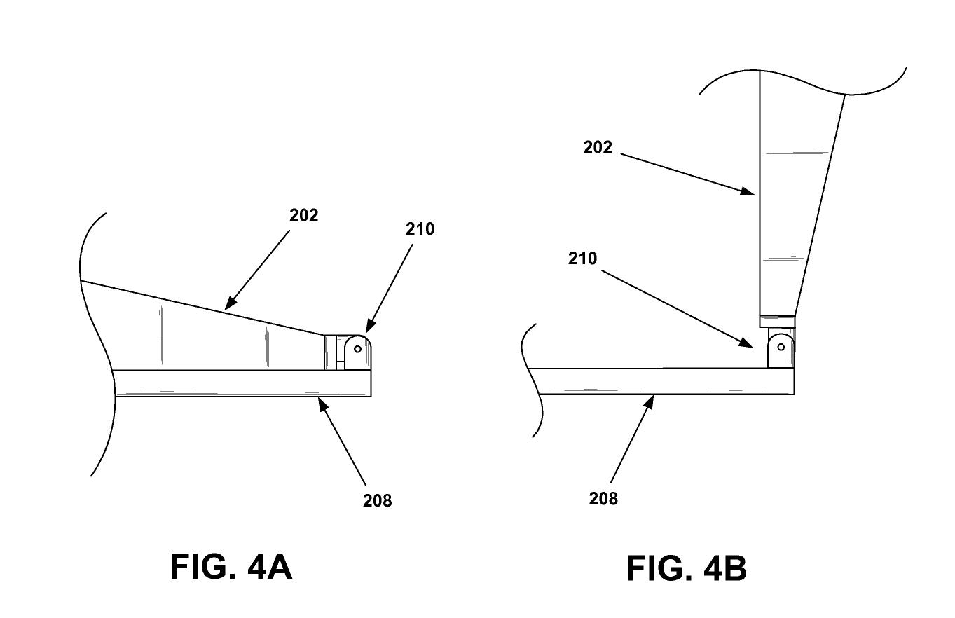

FIGS. 4A and 4B illustrate an exemplary hinge 210 for a hinged track plate apparatus 200. In particular, FIG. 4A is a diagram showing an exemplary hinge 210 in a closed position for normal operation, in accordance with an embodiment of the present invention. As shown in FIG. 4A, in normal operation the track plate assembly 202 rests on the base plate 208. In this manner, the track plates 204 of the track plate assembly 202 remove dirt, mud, and other debris from vehicle tires as the vehicles are driven over the hinged track plate apparatus 200. The base plate 208 prevents the track plate assembly 202 from sinking into the soft dirt or mud surface of the construction site. In addition, the base plate 208 collects the dirt, mud, and other debris that is removed from the vehicle tires. During maintenance, the track plate assembly 202 is lifted away from the base plate 208 as illustrated in FIG. 4B.

FIG. 4B is a diagram showing an exemplary hinge 210 in an open position for maintenance operations, in accordance with an embodiment of the present invention. As shown in FIG. 4B, during maintenance operations the track plate assembly 202 is lifted away from the base plate 208 about the hinge 210. In this manner, the surface of the base plate 208 can be easily cleaned to remove dirt, mud, and other debris that can be present after repeated use of the hinged track plate apparatus 200. As mentioned previously, dirt, mud, and other debris falls from the track plate assembly 202 onto the base plate 208 when the track plate assembly 202 is lifted away from the base plate 208. Since the track plates 204 no longer obstruct the surface of the base plate 208, the dirt, mud, and other debris can then be easily removed from the base plate 208 in a relatively short amount of time.

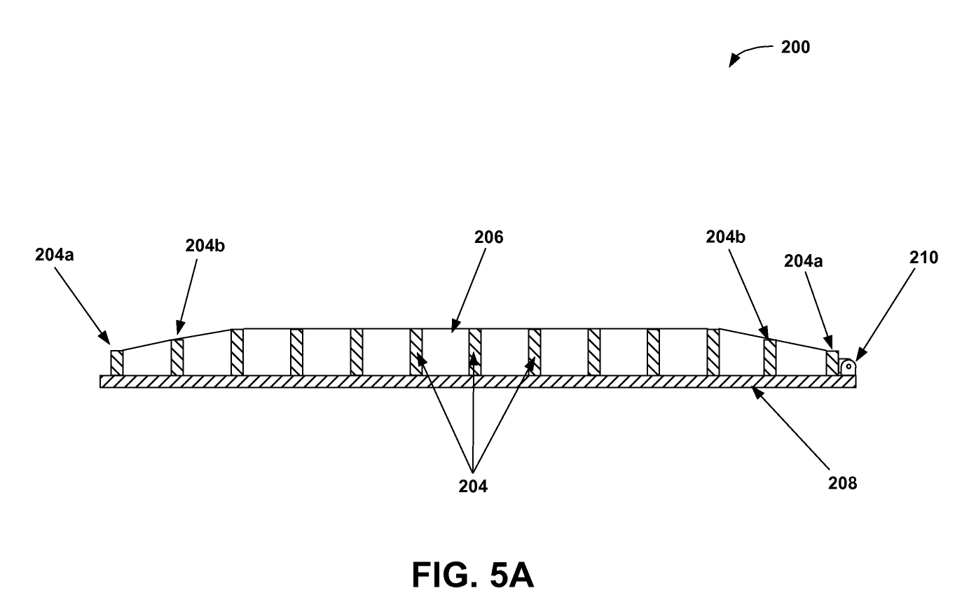

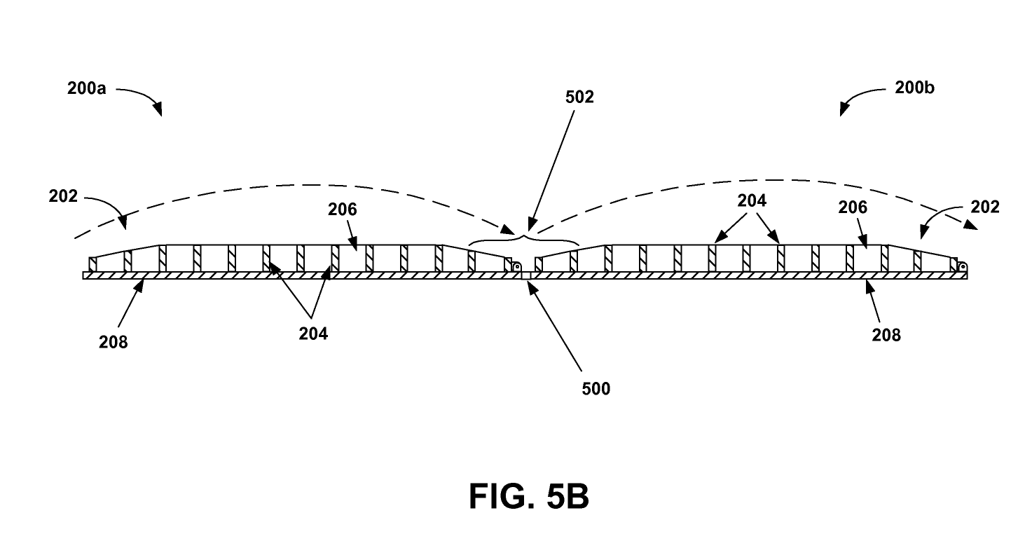

FIG. 5A is a cross sectional view of a hinged track plate apparatus 200, in accordance with an embodiment of the present invention. As described above, the hinged track plate apparatus 200 includes a base plate 208 hingably attached to a track plate assembly 202, which includes a plurality of track plates 204 arranged in parallel. Affixed to the plurality of track plates 204 is a plurality of track supports 206. In addition, one or more hinges 210 are attached to both the track plate assembly 202 and the base plate 208, which allow the track plate assembly 202 to be lifted away from the base plate 208 about the hinges 210.

In one embodiment of the present invention the height of the track plates 204 of the track plate assembly 202 varies near the edges of the track plate assembly 202. For example, in FIG. 5A, track plates 204a and 204b at the edges of the track plate assembly 202 are lower in height than the more centrally located track plates 204. In addition, the track supports 206 are tapered near the edges to stay within the heights of the track plates 204a and 204b near the edges of the track plate assembly 202. The lower height of the track plates 204a and 204b near the edges of the track plate assembly 202 provides easier access to vehicles entering upon the hinged track plate apparatus 200. That is, the lower height of the track plates 204a and 204b near the edges of the track plate assembly 202 provides a ramping effect to allow a gentler transition from ground level to hinged track plate apparatus 200. Although FIG. 5A illustrates two track plates 204a and 204b being lower in height than the more centrally located track plates 204, it should be noted that any number of track plates 204 can be lowered in height depending on the steepness or length of the ramping effect desired, as will be apparent to those skilled in the art after a careful reading of the present disclosure.

In one embodiment, multiple hinged track plates 200 can be attached together to form a larger surface. FIG. 5B is a cross sectional view of two hinged track plate apparatuses 200a and 200b attached together via attachment means 500, in accordance with an embodiment of the present invention. As described above, each hinged track plate apparatus 200a and 200b includes a base plate 208 hingably attached to a track plate assembly 202, which includes a plurality of track plates 204 arranged in parallel. Affixed to the plurality of track plates 204 is a plurality of track supports 206. In addition, one or more hinges 210 are attached to both the track plate assembly 202 and the base plate 208, which allow the track plate assembly 202 to be lifted away from the base plate 208 about the hinges 210.

In addition, in the embodiment of FIG. 5B, each base plate 208 includes attachment means 500 to attach one base plate 208 to an adjacent base plate 208. The attachment means 500 can be any device or configuration capable of attaching one base plate 208 to an adjacent base plate 208. For example, the attachment means 500 can be hooks, interlocking devices, clasps, pins, or any other device or configuration that capable of attaching one base plate 208 to an adjacent base plate 208.

Once attached together, the ramping effect from the lower track plates 204 near the edges of each hinged track plate apparatus 200a and 200b form a “dip” 502 in the surface of the connected hinged track plate apparatuses 200a and 200b. This dip 502 can induce additional vibration as vehicles travel across the surface of the connected hinged track plate apparatuses 200a and 200b. The increased vibration further assists in removing dirt, mud, and other debris from the vehicle tires. This effect can be enhanced when additional hinged track plate apparatuses 200 are added to the connected hinged track plate apparatuses 200a and 200b. Hence, it should be noted that any number of hinged track plate apparatuses 200 can be connected together using the attachment means 500 depending on the size of the cleaning surface needed, as will be apparent to those skilled in the art after a careful reading of the present disclosure.

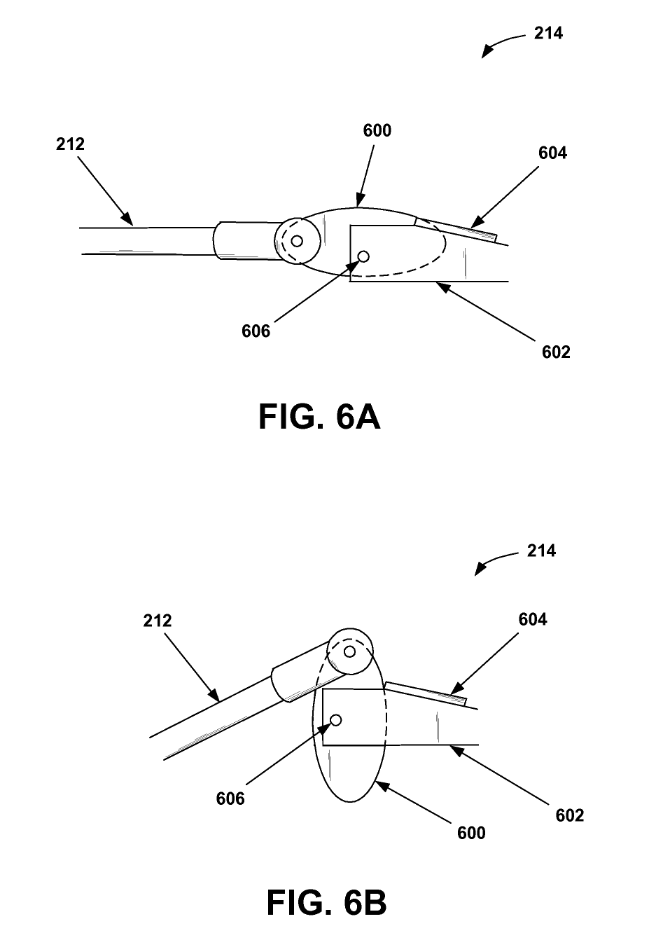

As mentioned above, embodiments of the present invention can utilize a cam lift assembly 214 to assist the lifting ram 212 in raising the track plate assembly 202 above the base plate 208. FIG. 6A is a diagram showing a cam lift assembly 214 in a closed position when the track plate assembly 202 is resting on the base plate 208, in accordance with an embodiment of the present invention. As shown in FIG. 6A, the lifting ram 212 is hingably connected to a cam 600. The cam 600 connected to a cam housing 602 via a cam pin 606. In addition, a cam stop 604 is mounted on the cam housing 602.

In operation, the cam lift assembly 214 is utilized to allow the lifting ram 212 to rise above the track plate assembly 202 in order to assist in lifting the track plate assembly 202 from the surface of the base plate 208. To perform this function, the cam 600 rotates about the cam pin 606 when the lifting ram is extended, as shown in FIG. 6B.

FIG. 6B is a diagram showing a cam lift assembly 214 in an opened position when the track plate assembly 202 is in a maintenance position above the base plate 208, in accordance with an embodiment of the present invention. When the lifting cam 212 is extended, the cam 600 rotates about the cam pin 606. The cam's 600 is stop upon contact with the cam stop 604, which stops the cam 600 from rotating beyond a predetermined position.

The rotation of the cam 600 moves the attached end of the lifting ram 212 to an elevated position above the track plate assembly 202. The elevated position of the lifting ram 212 then allows the lifting ram 212 to apply force in an increased upward direction, allowing the track plate assembly 202 to be raised above the base plate 208 more efficiently.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. An apparatus for removing debris from tires, comprising:
a base plate, the base plate having a width and length substantially greater than a thickness of the base plate;
a track plate assembly disposed above the base plate, the track plate assembly having a plurality of track plates connected to a plurality of track supports, each track plate having a length substantially greater than a height and thickness of the track plate; and
a hinge connected to the track plate assembly and the base plate, wherein the track plate assembly can be moved away from the base plate about the hinge,
whereby debris is removed from tires of vehicles moved across the track plate assembly.

2. An apparatus for removing debris from tires as recited in claim 1, further comprising a lifting ram hingably connected to the base plate and the track plate assembly, wherein the lifting ram is capable of moving the track plate assembly away from the base plate when the lifting ram is extended.

3. An apparatus for removing debris from tires as recited in claim 2, wherein the lifting ram is a hydraulic ram.

4. An apparatus for removing debris from tires as recited in claim 2, further comprising a cam lift assembly hingably connected to the track plate assembly and the lifting ram, the cam lift assembly capable of allowing an end of the lifting ram to rise above the track plate assembly to assist in lifting the track plate assembly from the base plate.

5. An apparatus for removing debris from tires as recited in claim 4, wherein the cam lift assembly includes a cam connected to a cam housing via a cam pin, the cam housing being coupled to a cam stop that stops the cam from rotating beyond a predetermined position.

6. An apparatus for removing debris from tires as recited in claim 1, wherein a predefined plurality of track plates near an edge of the track plate assembly have a height lower than track plates located centrally in the track plate assembly.

7. An apparatus for removing debris from tires as recited in claim 6, wherein each track plate of the predefined plurality of track plates near the edge of the track plate assembly has a greater height than the track plate closer to the edge of the track plate assembly.

8. An apparatus for removing debris from tires, comprising:
a base plate, the base plate having a width and length substantially greater than a thickness of the base plate;
a track plate assembly hingably attached to the base plate at an edge and disposed above the base plate, the track plate assembly having a plurality of track plates connected to a plurality of track supports, each track plate having a length substantially greater than a height and thickness of the track plate, wherein the track plate assembly can be moved away from the base plate about the hingably attached edge; and
a lifting ram hingably connected to the base plate and the track plate assembly, wherein the lifting ram is capable of moving the track plate assembly away from the base plate when the lifting ram is extended.

9. An apparatus for removing debris from tires as recited in claim 8, wherein the lifting ram is a hydraulic ram.

10. An apparatus for removing debris from tires as recited in claim 9, further comprising a hydraulic pump can connected to the hydraulic ram, wherein the hydraulic pump can provides hydraulic fluid to the hydraulic ram to facilitate use the hydraulic ram.

11. An apparatus for removing debris from tires as recited in claim 10, wherein the hydraulic fluid is a water mixture.

12. An apparatus for removing debris from tires as recited in claim 8, further comprising a cam lift assembly hingably connected to the track plate assembly and the lifting ram, the cam lift assembly capable of allowing an end of the lifting ram to rise above the track plate assembly to assist in lifting the track plate assembly from the base plate.

13. An apparatus for removing debris from tires as recited in claim 12, wherein the cam lift assembly includes a cam connected to a cam housing via a cam pin, the cam housing being coupled to a cam stop that stops the cam from rotating beyond a predetermined position.

14. An apparatus for removing debris from tires as recited in claim 8, wherein a predefined plurality of track plates near an edge of the track plate assembly have a height lower than track plates located centrally in the track plate assembly.

15. An apparatus for removing debris from tires as recited in claim 14, wherein each track plate of the predefined plurality of track plates near the edge of the track plate assembly has a greater height than the track plate closer to the edge of the track plate assembly.

16. An apparatus for removing debris from tires as recited in claim 15, further comprising a means for attaching one base plate to another base plate.
